(19) United States
(12) Patent Application Publication
(10) Pub. No.: US 2016/0132956 A1
(43) Pub. Date: May 12, 2016

(54) Electronic Commerce Platform and Transaction Method Using the Same

(71) Applicant: HODo Mobile Multimedia Co., Ltd, Taipei City (TW)

(72) Inventors: Chih Yao Lin, Taipei City (TW); Hsiao-Chuan Pan, Taipei City (TW); Lu-Jen Wang, Taipei City (TW); Guo-Xuan Hong, Taipei City (TW)

(21) Appl. No.: 14/929,654

(22) Filed: Nov. 2, 2015

(30) Foreign Application Priority Data
Nov. 11, 2014 (TW) 103138979

(51) Int. Cl. G06Q 30/06; G06Q 50/00

(52) U.S. Cl. CPC G06Q 30/0633; G06Q 30/0641; G06Q 50/01

(57) ABSTRACT

An electronic commerce platform is communicatively connected to a plurality of electronic devices each of which including a carrier. The electronic commerce platform includes a commodity managing module and a server. The commodity managing module is configured to receive at least a commodity information having a commodity characteristic and to transmit the commodity information to the server. The server includes a shopping interface producer and a match module. The shopping interface producer is configured to produce a shopping interface based on the commodity information. The match module is configured to transmit the commodity information to a matched carrier. The electronic device is configured to be communicatively connected to the shopping interface when a user clicks the commodity information shown on the carrier.

### BACKGROUND OF THE INVENTION

1. Field of Invention

The present invention relates to an electronic commerce platform, more particularly relates to an electronic commerce platform having a mobile application program producer.

2. Description of Related Art

An electronic commerce is a transaction method which is digitalized by the computer technology, the network technology, and the long-range communication technology. In generally, the commodity is publicized on the internet by a seller, and would be ordered by a buyer. Then, the transaction is completed via a logistics system and a third party payment system.

Many sellers establish a virtual shop to replace a physical shop on the internet, thereby saving cost of labor and rent. However, the virtual shop and the physical shop are both affected by the same important factor: total visits either. The virtual shop and the physical shop both need to be accessed/visited by potential consumers, so the commodity can be sold out quickly. In a condition of lacking promotions, the total visits are not enough, and it is difficult for the virtual shop and the physical shop to be lucrative.

On the other hand, many bloggers like to set a blog or a fan club to share the little nothings of life, and are devoted to increase the traffic of the blog or fan club. Some blogs or fan clubs have high network traffic. However, some bloggers may have know-how to operate the blog to maintain popularity, but may not know how to turn high network traffic to earning.

It is desirable to establish new patterns of electronic commerce mode so as to create a win-win situation for the bloggers and the sellers.

### SUMMARY OF THE INVENTION

In order to solve the above-mentioned problem, one object of the present invention is to provide an electronic commerce platform, and new patterns of the electronic commerce mode are generated by a collaboration between commodity providers and carrier providers.

The electronic commerce platform is provided, the electronic commerce platform is communicatively connected to a plurality of electronic devices each of which including a carrier, and the electronic commerce platform includes a commodity managing module and a server. The commodity managing module is configured to receive at least a commodity information having a commodity characteristic. The commodity managing module is configured to transmit the commodity information to the server. The server includes a shopping interface producer and a match module. The shopping interface producer is configured to produce a shopping interface based on the commodity information. The match module is configured to transmit the commodity information to a matched carrier based on the commodity characteristic of the commodity information. The electronic device is configured to be communicatively connected to the shopping interface when a user clicks the commodity information shown on the carrier.

In the above-mentioned electronic commerce platform, the carrier further comprises a shop window module configured to receive the commodity information.

In the above-mentioned electronic commerce platform, the electronic device is a smart phone, a tablet, a notebook or a desk-top computer.

In the above-mentioned electronic commerce platform, the carrier is an application program or a website.

In the above-mentioned electronic commerce platform, the application program is a mobile application program, and the website is a social networking site.

In the above-mentioned electronic commerce platform, the shopping interface is configured to produce an order information and the electronic commerce platform further comprises a carrier providing module configured to receive the order information.

In the above-mentioned electronic commerce platform, the carrier providing module further comprises a creating tool configured to produce the carrier.

A transaction method using the above-mentioned electronic commerce platform is provided, and the transaction method further comprises multiple steps of:

A10: receiving the commodity information by the commodity managing module;

A20: providing the carrier by a carrier provider;

A30: transmitting the commodity information to the server by the commodity managing module;

A40: producing the shopping interface by the shopping interface producer;

A50: transmitting the commodity information by the match module to the matched carrier based on the commodity characteristics of the commodity information;

A60: clicking the commodity information on the carrier by the user, and connecting the electronic device with the shopping interface; and

A70: ordering the commodity from the shopping interface by the user.

In the above-mentioned transaction method, the following steps are further provided:

A80: producing an order information by the shopping interface;

A90: transmitting the order information to the carrier providing module by the shopping interface; and

A100: displaying the order information by the carrier providing module.

In the above-mentioned electronic commerce platform, the following step is further provided:

A11: producing the carrier by the carrier providing module using a creating tool.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an electronic commerce platform of the present invention.

FIG. 2 illustrates a schematic diagram of a carrier.

FIG. 3A and FIG. 3B illustrate a flow chart of the transaction method using the electronic commerce platform.

### DESCRIPTION OF EMBODIMENTS

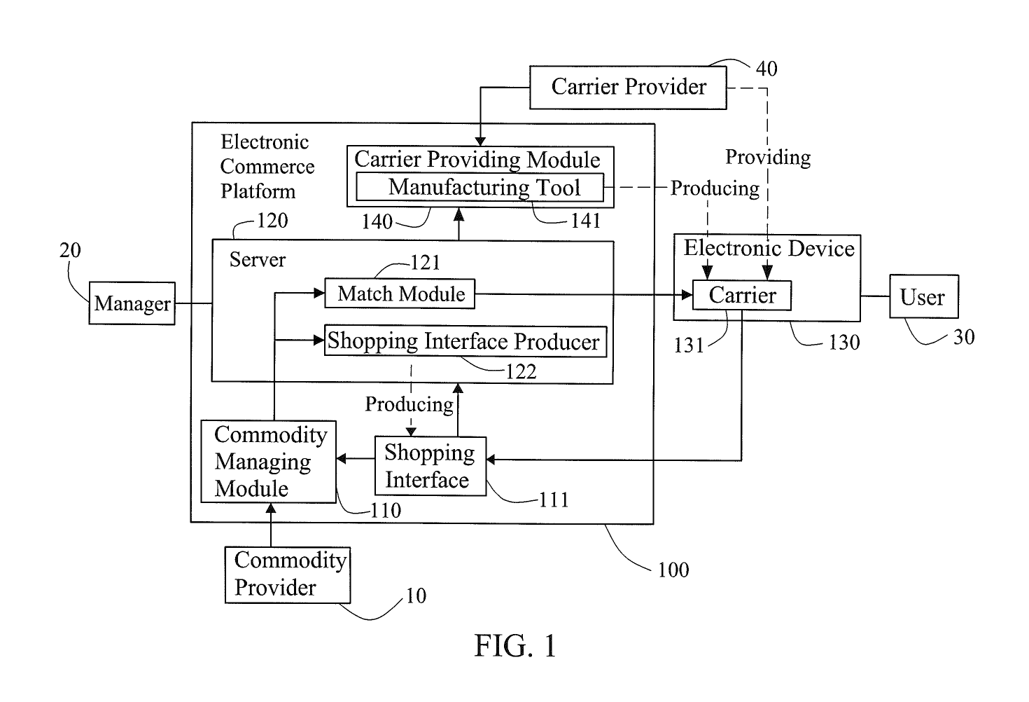

Please refer to FIG. 1 which illustrates an electronic commerce platform 100 of the present invention. The electronic commerce platform 100 operating by a user 30 (referred to as a consumer) is communicatively connected to a plurality of electronic devices each of which including a carrier. For example, the electronic device 130 is a smart phone, a tablet, a notebook, or a desk-top computer, and the carrier 131 is an application program or a website having high traffic. For example, the application program may be an application program for personal computers or a mobile application program (APP) for mobile devices. For example, the website is a social networking. The carrier 131 is provided by a carrier provider 40 and the carrier provider 40 may be a holder of the application program or anyone on the website. For example, the holder may be an APP developer, a blogger or a fans club operator, etc.

The electronic commerce platform 100 includes a commodity managing module 110, a server 120, and a carrier providing module 140. The commodity managing module 110 is operated by a commodity provider 10, and in this embodiment the commodity provider 10 is a person who sells a commodity on the electronic commerce platform 100. For example, the commodity provider 10 may be a seller of brand name products, a dealer, a wholesaler, or an individual online seller, etc. The commodity managing module 110 is configured to receive at least one commodity information having a commodity characteristic thereof so as to execute the following steps of the classifying, matching and sending. For example, a commodity characteristic of the commodity information may be the characteristic of a 3C product, a food, a cosmetic, or a daily commodity. For instance, the commodity information may be related to commodity on promotion or special offer or normal commodity provided by the commodity provider 10. The commodity managing module 110 is also configured to receive an order information, so as to make the commodity provider 10 realize a selling state of the commodity, and therefore the ensuing transaction process (for example: the shipment and payment) can be executed by the user 30. The commodity information is transmitted to the server 120 after being received completely.

The server 120 is managed by the manager 20. For example, the manager 20 may be an operating company operating the electronic commerce platform 100. The server 120 includes a shopping interface producer 122 and a match module 121, and the shopping interface producer 122 and the match module 121 are configured to perform the next step after the commodity information is received by the server 120. A shopping interface 111 is produced by the shopping interface producer 122 based on the commodity information received from the commodity provider 10. The shopping interface 111 is an interface which exhibits the commodity provided by the commodity provider 10, and has the function of the ordering and payment (such as credit card payment). The user 30 can order the commodity on the shopping interface 111. The shopping interface 111 can be edited via the commodity managing module 110 by the commodity provider 10 after the commodity is displayed on the shopping interface 111, so as to execute the on shelf or off shelf motion.

The match module 121 transmits the commodity information to a matched carrier 131 based on the commodity characteristics of the commodity information. For example, this matched carrier 131 may be a mobile application program used for inquiring the traffic of the superhighway. In this cause, when this matched carrier 131 has high download capacity and traffic, the user 30 of the carrier 131 is identified as a driver who drives frequently. The commodity information of the automotive-related commodity is sent to the carrier 131 by the match module 121. For example, the commodity information may be related to an event data recorder, a GPS homing advice or a maintenance coupon, etc.

The electronic commerce platform 100 provides a shop window module to the carrier provider 40 when the matched carrier 131 is provided to the electronic commerce platform 100. The shop window module is a software development kit (SDK) to be instilled in the matched carrier 131 and is configured to receive the commodity information. The carrier provider 40 can integrate the shop window module into the matched carrier 131, and the carrier provider 40 can also decide how the commodity information is presented. For example, a button named “shop” is created.

The user 30 can browse the commodity information in the matched carrier 131 after the matched carrier 131 receives the commodity information. The electronic device 130 is connected to the shopping interface 111 containing the commodity information when the user 30 clicks the commodity information, and the user 30 can buy the commodity from the shopping interface 111. An order information is produced by the shopping interface 111 and transmitted to the commodity managing module 110 and server 120 after the user 30 buys the commodity.

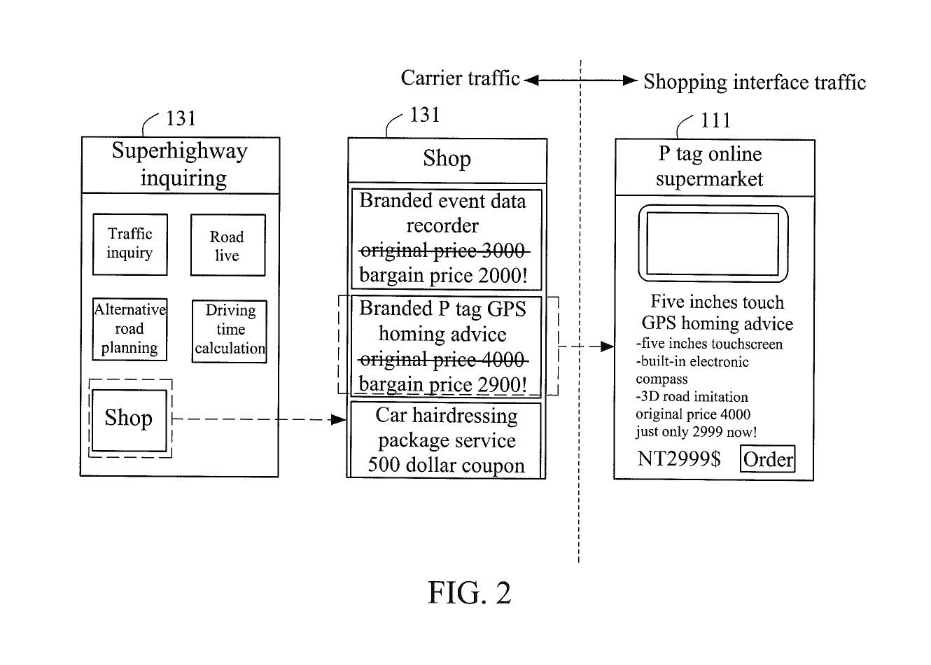

Please refer to FIG. 2 which illustrates a schematic diagram of a carrier 131. Based on the foregoing embodiment where the mobile application program (carrier 131) is for inquiring the traffic of the superhighway, the carrier 131 may have not only the functional buttons of traffic inquiry, live road status, driving time calculation, and alternative road planning, but also a button named “shop”. The user 30 can browse the commodity information received by the carrier 131 after the user 30 clicks the “shop” button. For example, the commodity information is a commodity price or a commodity name. For example, when the commodity information comprises a GPS homing device, the user 30 can buy the GPS homing advice from the shopping interface 111 by clicking the commodity information of the GPS homing device. After clicking, the electronic device 130 is connected to the shopping interface 111 selling the GPS homing advice.

It is noticeable that the user 30 uses the electronic device 130 to connect with the shopping interface 111 of the commodity provider 10, and the network traffic is guided to the shopping interface 111 instead of the carrier 131. Furthermore, the user 30 buys the commodity by ordering from the commodity provider 10, and receiving payment and shipment are executed by the commodity provider 10 instead of the carrier provider 40.

The carrier providing module 140 is operated by the carrier provider 40, and the carrier providing module 140 is connected to the server 120 for receiving the order information. Therefore, the carrier provider 40 can browse a state of the carrier 131 from the carrier providing module 140 after the carrier provider 40 provides the carrier 131. For example, the carrier provider 40 can browse the order information to realize how many users 30 connect to the shopping interface 111 by the carrier 131; the carrier provider 40 can also browse the commodity information to check the commodity information which is sent into the carrier 131.

Moreover, the carrier providing module 140 further comprises a creating tool 141. If another carrier provider 40 wants to join the electronic commerce platform 100 but no suitable carrier 131 is provided, and the carrier provider 40 can use the creating tool 141 to produce a suitable carrier 131 with the shop window module embedded therein. The creating tool 141 is configured to capture the data of social networking and video networking to produce one mobile application program. For example, one blogger can use the creating tool 141 to capture the data of the blog or video by himself so as to produce one exclusive mobile application program. By producing one carrier 131 using the creating tool 141 and transmitting the carrier 131 to the electronic commerce platform 100, the blogger becomes a carrier provider 40 and joins the electronic commerce platform 100.

In the electronic commerce platform 100 of the present invention, by the carrier 131 provided from the carrier provider 40, the user 30 can access the shopping interface 111 provided from the commodity provider 10, and the transaction is executed between the user 30 and the commodity provider 10 instead of the carrier provider 40. However, the carrier provider 40 can still inquire the state of the transaction between the user 30 and the commodity provider 10 through the carrier providing module 140. The carrier provider 40 would realize the situation at once and deal with a problem if a problem appears during the transaction, for example: removing the commodity information from the carrier 131.

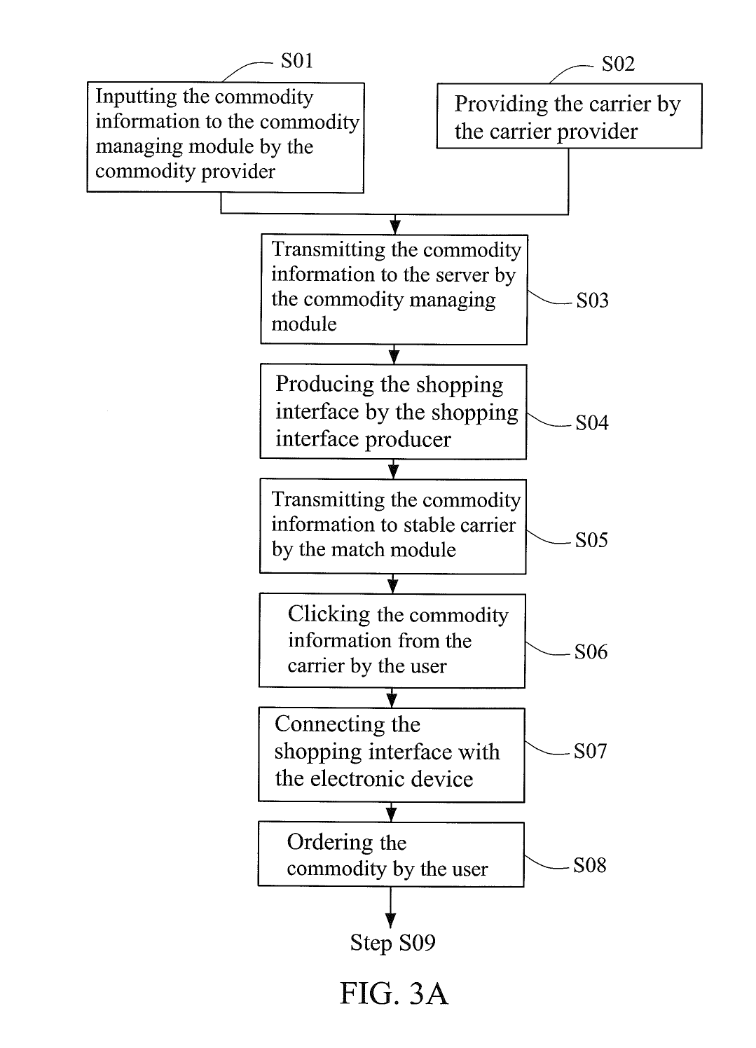

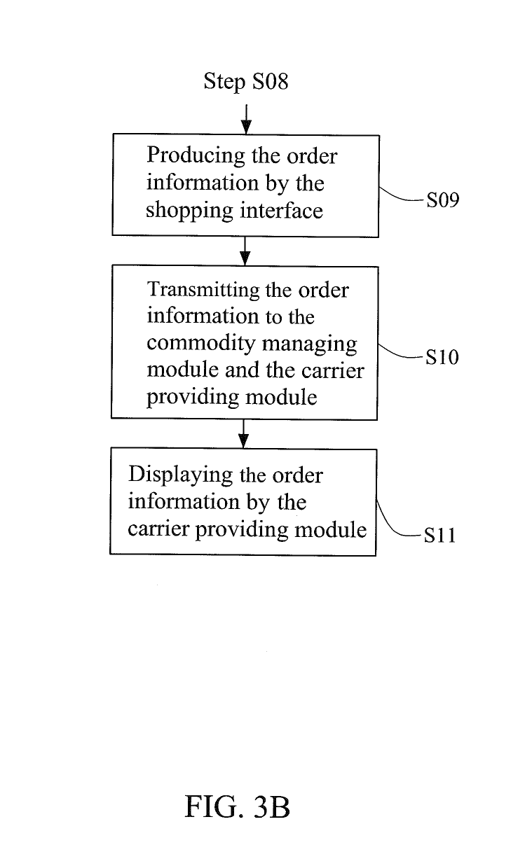

Please refer to FIG. 3A and FIG. 3B which illustrate a flow chart of the transaction method using the electronic commerce platform 100. First, the commodity provider 10 provides and inputs the commodity information to the commodity managing module 110 (step S01), and the carrier 131 is provided by the carrier provider 40 (step S02). The carrier 131 would be produced using the creating tool 141 if no suitable carrier 131 is provided by the carrier provider 40. The commodity managing module 110 transmits the commodity information to the server 120 after the commodity information is inputted completely (step S03). Then, the commodity information is handled by the shopping interface producer 122 and the match module 121 of the server 120, the shopping interface producer 122 can produce one shopping interface 111 corresponding to the commodity information (step S04). The match module 121 transmits the commodity information to a matched carrier 131 based on the commodity characteristics of the commodity information (step S05). Therefore, the user 30 using the matched carrier 131 can see the commodity information on the carrier 131 (step S06). The electronic device 130 installed with the matched carrier 131 is connected to the shopping interface 111 corresponding to the commodity information after the user 30 clicks the commodity information (step S07). And then, the user 30 can order the commodity from the shopping interface 111 (step S08). The order information is produced by the shopping interface 111 after ordering is completely (step S09). Then, the order information is transmitted to the commodity managing module 110 and the carrier providing module 140 (step S10). The carrier providing module 140 displays the order information after receiving the order information (step S11), so as to make the carrier provider 40 realize the transaction state between the user 30 and the commodity provider 10. The commodity provider 10 can execute receiving payment and shipment based on the order information after the commodity provider 10 receives the order information from the commodity managing module 110.

In a traditional electronic commerce mode, the seller needs to do the works of stocking, shipment, receiving payment, and management, etc. by himself, and the seller needs to create enough traffic to ensure selling of the commodity. It is difficult for the seller to do so much. By the electronic commerce platform 100 of the present invention, it is possible to match the suitable carrier provider 40 who is capable of creating high interne traffic and total visit and a commodity provider 10 who has the resources of providing commodity, cash flow, and logistics. Through cooperation between the carrier provider 40 and the commodity provider 10, the commodity information is sent to potential consumer groups by the match module 121 so as to increase the efficiency of the commodity selling. Furthermore, the difficulty of operating virtual shops by the commodity provider 10 is also reduced. The carrier provider 40 can earn the related advertising fee and the commodity provider 10 can also benefit from selling the commodity. It is a win-win solution for both the carrier provider 40 and commodity provider 10.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. An electronic commerce platform communicatively connected to at least an electronic device, the electronic device including a carrier, the electronic commerce platform including:
a commodity managing module configured to receive at least one commodity information having a commodity characteristic thereof and transmit the at least one commodity information to a server, and the server including:
a shopping interface producer configured to produce a shopping interface based on the commodity information; and
a match module configured to transmit the commodity information to a matched carrier based on the commodity characteristic of the commodity information;
wherein the electronic device is configured to be communicatively connected to the shopping interface when a user clicks the commodity information shown on the carrier.

2. The electronic commerce platform of claim 1, wherein the carrier further comprises a shop window module configured to receive the commodity information.

3. The electronic commerce platform of claim 1, wherein the electronic device is a smart phone, a tablet, a notebook or a desk-top computer.

4. The electronic commerce platform of claim 1, wherein the carrier is an application program or a website.

5. The electronic commerce platform of claim 4, wherein the application program is a mobile application program, and the website is a social networking site.

6. The electronic commerce platform of claim 1, wherein the shopping interface is configured to produce an order information and the electronic commerce platform further comprises a carrier providing module configured to receive the order information.

7. The electronic commerce platform of claim 4, wherein the carrier providing module further comprises a creating tool configured to produce the carrier.

8. A transaction method using the electronic commerce platform of claim 1:
A10: receiving the commodity information by the commodity managing module;
A20: providing the carrier by a carrier provider;
A30: transmitting the commodity information to the server by the commodity managing module;
A40: producing the shopping interface by the shopping interface producer;
A50: transmitting the commodity information by the match module to the matched carrier based on the commodity characteristics of the commodity information;
A60: clicking the commodity information on the carrier by the user, and connecting the electronic device with the shopping interface; and
A70: ordering the commodity from the shopping interface by the user.

9. The transaction method of claim 8, the electronic commerce platform further comprising a carrier providing module, and the transaction method further comprising the following steps:
A80: producing an order information by the shopping interface;
A90: transmitting the order information to the carrier providing module by the shopping interface; and
A100: displaying the order information by the carrier providing module.

10. The electronic commerce platform of claim 8, further comprising the following step:
A11: producing the carrier using a creating tool by the carrier providing module.
